(19) United States
(12) Patent Application Publication
(10) Pub. No.: US 2014/0044944 A1
(43) Pub. Date: Feb. 13, 2014

(54) COATING MATERIAL FOR ALUMINUM DIE CASTING MOLD AND METHOD OF MANUFACTURING THE COATING MATERIAL

(71) Applicants: HYUNDAI MOTOR COMPANY, Seoul (KR); KIA MOTORS CORPORATION, Seoul (KR)

(72) Inventors: Sung-Chul Cha, Seoul (KR); Dong-Ha Kang, Seoul (KR)

(73) Assignees: KIA MOTORS CORPORATION, Seoul (KR); HYUNDAI MOTOR COMPANY, Seoul (KR)

(21) Appl. No.: 13/718,671

(22) Filed: Dec. 18, 2012

(30) Foreign Application Priority Data
Aug. 7, 2012 (KR) 10-2012-86083

(51) Int. Cl. C09D 1/00

(52) U.S. Cl. CPC C09D 1/00
USPC 428/216; 427/135; 428/697; 428/336

(57) ABSTRACT

Disclosed is a coating material for an aluminum die casting mold and a method of manufacturing the coating material. The coating material includes a CrN bonding layer formed on a surface of a substrate, a TiAlN/CrN nano multi-layer disposed on a surface of the CrN bonding layer, and a TiAlN/CrSi(C)N nano multi-layer disposed on a surface of the TiAlN/CrSiCN nano multi-layer. The coating material for an aluminum die casting mold may maintain the physical properties of a mold under a high temperature environment due to the superior seizure resistance, heat resistance and high-temperature stability of the coating material, thereby extending the lifespan of the mold.

### CROSS-REFERENCE TO RELATED APPLICATION

This application claims priority under 35 U.S.C. §119 to Korean Patent Application No. 10-2012-86083, filed on Aug. 7, 2012, in the Korean Intellectual Property Office, the disclosure of which is incorporated herein by reference in its entirety.

### BACKGROUND

1. Technical Field

This invention relates to a coating material for an aluminum die casting mold and a method of manufacturing the coating material, more particularly, to a coating material for an aluminum die casting mold, having a multi-layered structure including a CrN bonding layer, a TiAlN/CrN nano multi-layer, a TiAlN/CrSiN or TiAlN/CrSiCN nano multi-layer, and showing improved seizure resistance and durability of a mold, and a method of manufacturing the coating material.

2. Background of the Invention

In recent years, as manufacturing processes have become automated and executed at high speeds, various metal materials such as molds, mechanical structures, etc., are used under more severe conditions.

In particular, an aluminum die casting mold requires a high level of physical properties due to a continuous high load and high impact, thus the lifespan of an aluminum die casting mold is determined by the mold materials, mold designs, working conditions, heat treatment of a mold, and surface treatment, etc. The lifespan decreases due to heat checking by thermal shock, seizure and wearing by molten aluminum, and heat softening caused by the high temperature working environment (e.g., up to 750° C.), and on the like.

Thus, various attempts have been made to prevent shortening of mold lifespan and to maintain mold performance. Specifically, active research has been widely conducted to develop coating materials with superior physical properties such as seizure resistance, wear resistance, low wear property, heat resistance, acid resistance, and the like.

For a typical mold, a nitride or carbide based on Titanium (Ti), Chromium (Cr), etc., is used as a surface protective coating material. In particular, in=an aluminum die casting mold, titanium aluminum nitride (TiAIN) or aluminum chrome nitride (AlCrN) is typically used as a coating material. However, TiAIN does not have sufficient heat resistance to be used as a coating material for an aluminum die casting mold which is exposed to a high-temperature environment of up to about 750° C., and has poor heat stability, for example, showing poor physical properties when exposed to a high temperature environment.

Additionally, AlCrN has relatively superior heat resistance compared to TiAIN, but has inferior seizure resistance, so a molten alloy such as aluminum may be easily attached to a surface of a mold, resulting in shortened lifespan of the mold and a decrease in quality of a cast iron product.

The description provided above as a related art of the present invention is just for helping understanding the background of the present invention and should not be construed as being included in the related art known by those skilled in the art.

### SUMMARY

The present invention has been proposed to solve the above drawbacks and provides a coating material for an aluminum die casting mold, having superior heat resistance, high temperature stability and seizure resistance compared to a conventional Titanium Aluminum Nitride (TiAlN) or Aluminum Chromium Nitride (AlCrN) coating material, and thus can extend the lifespan of a mold, and a method of manufacturing the coating material.

A coating material for an aluminum die casting mold according to an embodiment of the present invention includes a Chromium Nitride (CrN) bonding layer formed on a surface of a substrate, a TiAlN/CrN nano multi-layer disposed on a surface of the CrN bonding layer, and a TiAlN/CrSi(C)N (Chromium Silicide Carbon Nitride) nano multi-layer disposed on a surface of the TiAlN/CrN nano multi-layer.

In addition, the TiAlN/CrSi(C)N nano multi-layer may have a thickness of 0.5 to 5 μm. The CrN bonding layer and the TiAlN/CrN nano multi-layer may have thicknesses of 0.5 to 5 μm, respectively.

A method of manufacturing a coating material for an aluminum die casting mold according to an embodiment of the present invention includes depositing a CrN bonding layer on a surface of a substrate using a Cr target in response to forming a nitrogen atmosphere by projecting nitrogen gas through a gas inlet, depositing a TiAlN/CrN nano multi-layer on a surface of the deposited CrN bonding layer using a TiAl target and a Cr target, and depositing a TiAlN/CrSiN nano multi-layer on a surface of the deposited TiAlN/CrN nano multi-layer using a TiAl target and a CrSi target.

A method of manufacturing a coating material for an aluminum die casting mold according to an embodiment of the present invention includes depositing a CrN bonding layer on a surface of a substrate using a Cr target in response to forming a nitrogen atmosphere by projecting nitrogen gas through a gas inlet, depositing a TiAlN/CrN nano multi-layer on a surface of the deposited CrN bonding layer using a TiAl target and a Cr target, and depositing a TiAlN/CrSiN nano multi-layer on a surface of the deposited TiAlN/CrN nano multi-layer using a TiAl target and a CrSi target in response to forming an acetylene gas (C₂H₂) atmosphere by projecting acetylene gas (C₂H₂) through a gas inlet.

In addition, the depositing of the TiAlN/CrSiN nano multi-layer may be performed by depositing the TiAlN/CrSiN nano multi-layer to a thickness of about 0.5 to 5 μm. The depositing of the TiAlN/CrSiCN nano multi-layer may be performed by depositing the TiAlN/CrSiCN nano multi-layer to a thicknesses of about 0.5 to 5 μm. The depositing of the CrN bonding layer may be performed by depositing the CrN bonding layer to a thicknesses of about 0.5 to 5 μm, and the depositing of the TiAlN/CrN nano multi-layer may be performed by depositing the TiAlN/CrN nano multi-layer to a thicknesses of about 0.5 to 5 μm.

Furthermore, the depositing of the TiAlN/CrN nano multi-layer may be performed by depositing the TiAlN/CrN nano multi-layer wherein a ratio of Ti, Al and Cr in the TiAlN/CrN nano multi-layer is 1:1:1. The depositing of the TiAlN/CrSiN nano multi-layer may be performed by depositing the TiAlN/CrSiN nano multi-layer wherein a ratio Ti, Al, Cr and Si in the TiAlN/CrSiN nano multi-layer is 1:1:0.9:0.1. The depositing of the TiAlN/CrSiCN nano multi-layer may be performed by depositing the TiAlN/CrSiCN nano multi-layer wherein a ratio of Ti, Al, Cr, Si and C in the TiAlN/CrSiCN nano multi-layer is 1:1:0.8:0.1:0.1.

Furthermore, the deposition may be performed using a physical vapor deposition (PVD) method.

### BRIEF DESCRIPTION OF THE DRAWINGS

The above and other features of the present invention will now be described in detail with reference to exemplary embodiments thereof illustrated the accompanying drawings which are given hereinbelow by way of illustration only, and thus are not limitative of the present invention, and wherein:

FIG. 1 is an exemplary image showing a seizure on a core fin of an aluminum die casting mold, according to the related art;

FIG. 2 is an exemplary diagram showing a structure of a TiAlCrSi(C)N coating material, according to an exemplary embodiment of the present invention;

FIG. 3 is an exemplary diagram showing a physical vapor deposition (PVD) system used to manufacture the coating material according to an exemplary embodiment of the present invention;

FIG. 4 is an exemplary image showing a mold coated with a conventional TiAlN coating material, washed with sodium hydroxide after being dipped and rotated in an aluminum molten metal for 6 hours;

FIG. 5 is an exemplary image showing a mold coated with a conventional AlCrN coating material, washed with sodium hydroxide after dipped and rotated in an aluminum molten metal for 6 hours;

FIG. 6 is an exemplary image showing a mold coated with the coating material according to an exemplary embodiment of the present invention, washed with sodium hydroxide after dipped and rotated in an aluminum molten metal for 6 hours; and

FIG. 7 is an exemplary image showing a mold coated with the coating material according to an exemplary embodiment of the present invention, washed with sodium hydroxide after dipped and rotated in an aluminum molten metal for 27 hours.

### DETAILED DESCRIPTION OF EXEMPLARY EMBODIMENT

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about.”

The term “TiAlCrSi(C)N” used in the present invention is referred to as “TiAlCrSiN” or “TiAlCrSiCN” and the term “TiAlN/CrSi(C)N” used herein is referred to as “TiAlN/CrSiN” or “TiAlN/CrSiCN.”

Embodiments of the present invention will be described below in detail with reference to the accompanying drawings.

FIG. 1 is an exemplary image showing an occurrence of seizure on a core fin of an aluminum die casting mold. As shown in FIG. 1, when casting is performed using an aluminum die casting mold, a seized product 10 is generated from an aluminum molten metal. The seized product 10 may reduce the hardness of a surface of the mold, and may cause leaks, damage of a mold, etc., thereby shortening the lifespan of the mold.

Moreover, an aluminum die casting mold generally requires a high level of physical properties to endure severe conditions caused by ultra high pressure and high cycle. TiAlN or AlCrN used as a conventional coating material may exhibit poor heat resistance, high temperature stability, seizure resistance, etc., and thus has limitations in extending the lifespan of a mold. Therefore, the present invention provides a TiAlCrSi(C)N coating material.

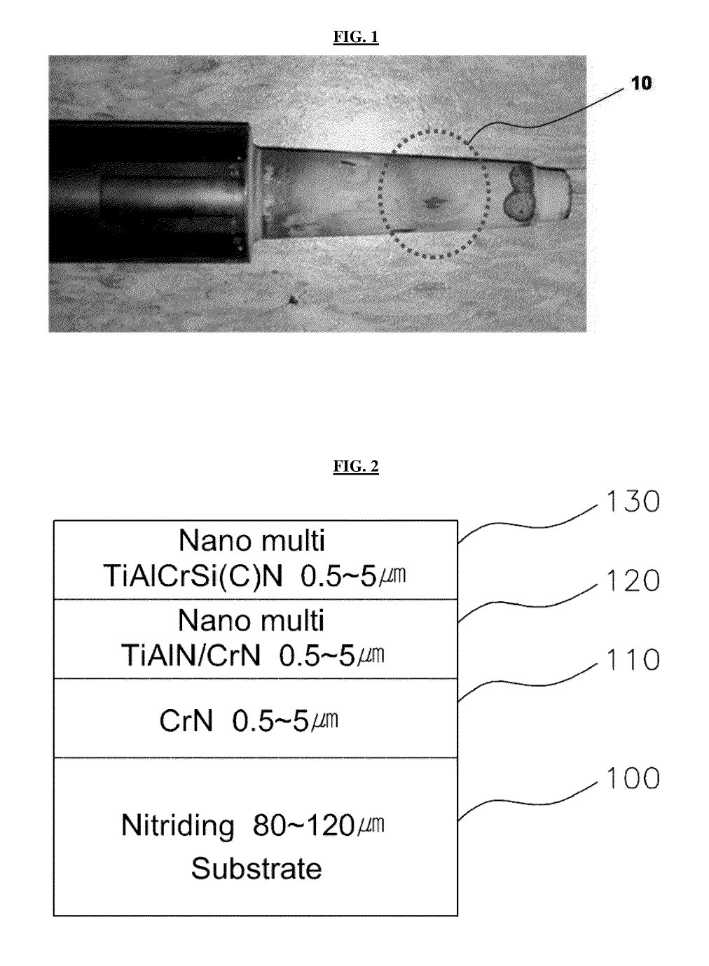

FIG. 2 is a diagram showing a structure of a TiAlCrSi(C)N coating material according to the present invention. As shown in FIG. 2, the coating material according to an exemplary embodiment of the present invention may include a CrN bonding layer 110 formed on a surface of a substrate 100, a TiAlN/CrN nano multi-layer 120 disposed on a surface of the CrN bonding layer 110 configured to support a functional layer, and the functional layer TiAlN/CrSi(C)N nano multi-layer 130 disposed on a surface of the TiAlN/CrN nano multi-layer 120.

Furthermore, the substrate of the aluminum die casting mold may further include a nitride layer having a thickness of 80 to 120 μm through a nitrification process when necessary.

Moreover, the CrN bonding layer 110 is widely used for its high chemical stability such as anti-corrosiveness and for its mechanical properties such as hardness, friction resistance, lubrication property, etc. Therefore, in the present invention, the CrN bonding layer 110 may be used as a bonding layer to minimize residual stress and improve toughness, fatigue resistance, impact resistance, etc.

In addition, the TiAlN/CrN nano multi-layer 120 may be used as a supporting layer to improve characteristics such as heat resistance, acid resistance, seizure resistance, etc., required for an aluminum die casting mold. The TiAlN/CrSi(C)N nano multi-layer 130 may be used as a functional layer to improve heat resistance, acid resistance, wear resistance, low friction at high temperature and seizure resistance a characteristic of the coating material of the present invention.

In other words, wear resistance and impact resistance are conflicting properties, which may be improved using the CrN bonding layer 110 having high impact resistance together with the TiAlN/CrN nano multi-layer 120 and the TiAlN/CrSi(C)N nano multi-layer 130, both of which have high impact resistance.

Further, the CrN bonding layer 110 may have a thickness of about 0.5 to 5 μm. When the thickness is less than about 0.5 μm, insufficient quantities of constituent materials may cause a decrease in effectiveness of the resistances, whereas, when the thickness exceeds about 0.5 μm, the coating layer may be peeled off.

In addition, the TiAlN/CrN nano multi-layer 120 and the TiAlN/CrSi(C)N nano multi-layer 130 may have thicknesses of about 0.5 to 5 μm, respectively. When the thicknesses are less than about 0.5 μm, the two different layers may mix causing difficulty in forming the multi-layered structure, and thereby reducing the qualities of the materials. On the other hand, when the thicknesses exceed about 0.5 μm, matched transformation between two layers may be destroyed, thereby degrading the hardness.

Methods of coating a surface of a metal substrate with a coating material may be classified into a PVD method and a chemical vapor deposition (CVD) method. PVD is a dry processing method that provides negative polarity to a target material (e.g., substrate) and deposits an ionized metal material on a surface of the material while supplying the ionized metal in a vapor state. In the PVD method, the ionized metal material may be uniformly coated onto the surface of the substrate, and the adhesiveness may be improved using fine ion particles.

In other words, in the present invention, the PVD method uses arc, high power impulse magnetron sputtering (HIPIMS) and inductive coupled plasma (ICP) to obtain a nano level deposition and high speed coating of coating material particles.

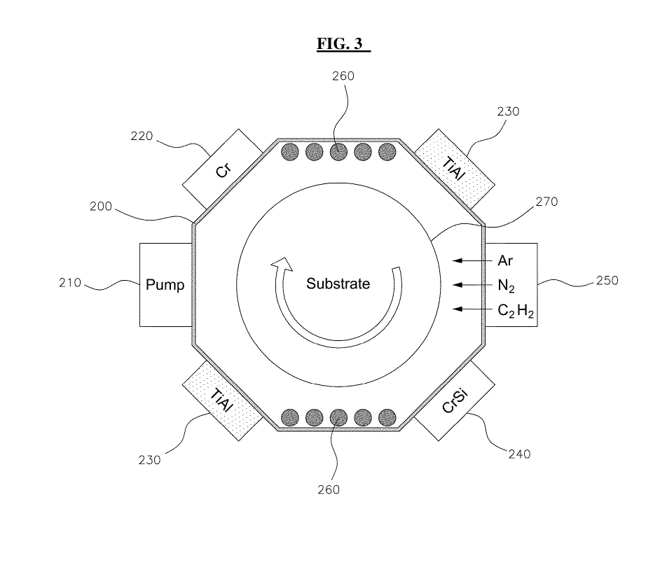

FIG. 3 is an exemplary diagram showing a PVD system used to manufacture the coating material according to the present invention. As shown in FIG. 3, the PVD system may include a chamber 200; a pump 210, a Cr target 220, a TiAl target 230, a CrSi target 240, and a gas inlet 250; and a heating unit 260, installed on the chamber 200; and a mold (e.g., a substrate) mounted to a rotary holder 270 within the chamber 200.

As a coating pre-treatment process, the interior of the chamber 200 may be converted into a vacuum state using a pump 210, and converted into a plasma state by projecting argon gas through a gas inlet 250.

Moreover, the surface of the substrate 100 may be cleaned and activated by heating the chamber 200 to about 80° C. using the heating unit 260 and by applying a predetermined voltage to the mold to allow positive argon ions to collide with a surface of the mold. Furthermore, a nitrogen gas (N₂) atmosphere may be formed by projecting nitrogen gas (N₂) in the chamber 200 through the gas inlet 250, and a CrN bonding layer 110 may be deposited to a thickness of about 0.5 to 5 μm by supplying Cr ions to the surface of the substrate 100 using a Cr target 220.

In addition, by selectively exposing the mold onto which the CrN bonding layer 110 is deposited to a TiAl target 230 configured to provide Ti and Al ions and a Cr target 220 configured to provide Cr ions using a rotary holder 270, a TiAlN/CrN nano multi-layer 120, having a structure in which TiAlN layers and CrN layers are alternatively stacked on a surface of the CrN bonding layer 110, may be deposited to a thickness of about 0.5 to 5 μm.

The TiAlN/CrN nano multi-layer 120 may be a supporting layer configured to improve heat resistance, acid resistance, wear resistance and toughness of the substrate 100, and may be deposited to create a ratio of Ti, Al and Cr in the TiAlN/CrN nano multi-layer 120 to be 1:1:1 according to alternative stacking of the respective layers to maximize the heat resistance, acid resistance, wear resistance, and toughness of the substrate.

Further, by selectively exposing the mold onto which the TiAlN/CrN nano multi-layer 120 is deposited to the TiAl target 230 configured to provide Ti and Al ions and a CrSi target 240 configured to provide Cr and Si ions, the TiAlN/CrN nano multi-layer 120, having a structure in which TiAlN layers and CrN layers are alternatively stacked on a surface of the TiAlN/CrN nano multi-layer 120, may be deposited to a thickness of about 0.5 to 5 μm. When the above-described processes are performed in response to forming the acetylene gas (C₂H₂) atmosphere in the chamber 200 by projecting acetylene gas (C₂H₂) in the chamber 200 through the gas inlet 250, the TiAlN/CrSiCN nano multi-layer, having a structure in which TiAlN layers and CrSiCN layers are alternatively stacked on the surface of the TiAlN/CrN nano multi-layer 120, may be deposited with supplied carbons (C).

The TiAlN/CrSi(C)N nano multi-layer 130 may be a functional layer configured to improve heat resistance, acid resistance, wear resistance, low friction at high temperature and seizure resistance, a property of the coating material according to the present invention. Due to the alternating stacking of the respective layers to maximize the above described effects, the TiAlN/CrSi(C)N nano multi-layer 130 may be deposited to create a ratio Ti, Al, Cr, Si and (C) to be 1:1:(0.8 to) 0.9:0.1:(0.1).

TABLE 1

| | Comparative | Comparative | |
|---|---|---|---|
| | Embodiment 1 | Embodiment 2 | Embodiment 1 |
| Surface treatment/coating | TiAlN | AlCrN | TiAlCrSiCN |
| Method | PVD | PVD | PVD |
| Thickness (μm) | 9.5 (5CrN—4.5TiAlN) | 9.8 (5CrN—4.8AlCrN) | 9.7 (5CrN/3.7TiAlCrN—1TiAlCrCN) |
| Adhesiveness (N) | 49.2 | 48.3 | 51 |
| Hardness (HV) | 3,179 | 3,252 | 3,367 |
| Hardness (HV) after left at | 2,850 | 3,213 | 3,359 |
| high temperature | | | |
| Oxidation Temperature (° C.) | 850 | 900 | 950 |
| Seizure resistance | Normal | Poor | Excellent |

Table 1 lists the results obtained through comparison of TiAlCrSiCN coating material according to an exemplary embodiment of the present invention with conventional TiAlN and AlCrN coating materials.

The hardness was measured by inserting an indenter into a specimen at an ultra low load; the adhesiveness was measured under a load when the layers began to peel off when increasing the load applied to a diamond tip by applying forces to the coated surface using the diamond tip to make a row of grooves; the thickness was measured using a trajectory made by pressurizing a coated surface under uniform load using iron beads; the oxidation temperature was measured as temperature obtained when the thickness of an oxidized layer formed through oxidation reached about 200 nm in response to maintaining the temperature at a particular temperature under an N₂-20% O₂ atmosphere in a high temperature chamber; and the variation in hardness was measured in response to maintaining a high temperature of about 700° C. under an N₂-20% O₂ atmosphere in the chamber.

As listed in Table 1, the oxidation temperature of the coating material according to the present invention was 950° C., which was higher than the oxidation temperatures of the TiAlN and AlCrN coating materials, indicating that the coating material according to the present invention has higher heat resistance than the conventional coating materials.

Additionally, the hardness of the coating material according to the present invention was 3367 HV, and the hardness in response to maintaining a high temperature was 3359 HV, showing less changes in physical properties compared to those of the conventional coating materials, indicating that the coating material according to the present invention has higher high temperature stability than the conventional coating materials.

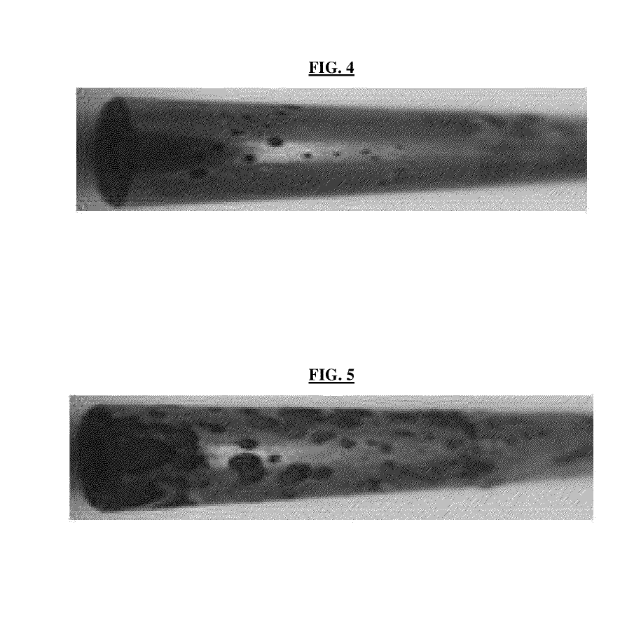

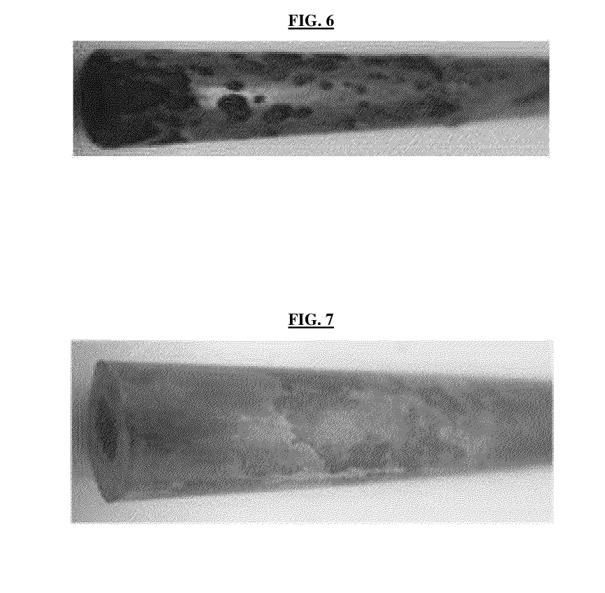

FIG. 4 is an exemplary image showing a mold coated with a conventional TiAlN coating material, washed with sodium hydroxide after being dipped and rotated in an aluminum molten metal for 6 hours. FIG. 5 is exemplary an image showing a mold coated with a conventional AlCrN coating material, washed with sodium hydroxide after being dipped and rotated in an aluminum molten metal for 6 hours. FIG. 6 is an exemplary image showing a mold coated with the coating material of the present invention, washed with sodium hydroxide after being dipped and rotated in an aluminum molten metal for 6 hours. FIG. 7 is exemplary an image showing a mold coated with the coating material of the present invention, washed with sodium hydroxide after being dipped and rotated in an aluminum molten metal for 27 hours.

Furthermore, the sodium hydroxide may be used to remove an aluminum-seized product. In the molds coated with conventional coating materials, surface defects were observed on the mold. However, surface defects were not observed on the mold coated with the coating material of the present invention. Surface defects were not observed on the mold coated with the coating material of the present invention due to the seizure resistance of the mold improving through use of the coating material of the present invention, and due to the presence of the TiAlN/CrSi(C)N nano multi-layer.

As described above, the coating material of the present invention has superior physical properties such as acid resistance, heat resistance, hardness and seizure resistance compared to the conventional coating materials, and thus may be useful in extending the lifespan of an aluminum die casting mold, resulting in various effects of reducing a mold maintenance cost and improving productivity, etc.

In general, seizure resistance means a property of preventing some of a molten metal from attaching to the mold during a casting process. Accordingly, the coating material of the present invention can be useful in improving quality and productivity of a cast-iron product due to the high seizure resistance compared to a conventional TiAlN or AlCrN coating material.

The invention has been described in detail with reference to exemplary embodiments thereof. However, it will be appreciated by those skilled in the art that changes or modifications may be made in these embodiments without departing from the principles of the invention, the scope of which is defined in the accompanying claims and their equivalents.

What is claimed is:

1. A coating material for an aluminum die casting mold, comprising:
a CrN bonding layer formed on a surface of a substrate;
a TiAlN/CrN nano multi-layer disposed on a surface of the CrN bonding layer; and
a TiAlN/CrSi(C)N nano multi-layer disposed on a surface of the TiAlN/CrN nano multi-layer.

2. The coating material for an aluminum die casting mold of claim 1, wherein the TiAlN/CrSi(C)N nano multi-layer has a thickness of about 0.5 to 5 μm.

3. The coating material for an aluminum die casting mold of claim 1, wherein the CrN bonding layer and the TiAlN/CrN nano multi-layer have thicknesses of about 0.5 to 5 μm, respectively.

4. A method of manufacturing a coating material for an aluminum die casting mold, comprising:
depositing a CrN bonding layer on a surface of a substrate using a Cr target in response to forming a nitrogen gas (N₂) atmosphere by projecting nitrogen gas (N₂) through a gas inlet of a chamber;
depositing a TiAlN/CrN nano multi-layer on a surface of the deposited CrN bonding layer using a TiAl target and the Cr target; and
depositing a TiAlN/CrSiN nano multi-layer on a surface of the deposited TiAlN/CrN nano multi-layer using the TiAl target and a CrSi target.

5. The method of claim 4, wherein the depositing of the TiAlN/CrSiCN nano multi-layer further comprises depositing the TiAlN/CrSiN nano multi-layer to a thickness of about 0.5 to 5 μm.

6. The method of claim 5, wherein the depositing of the CrN bonding layer further comprises:
depositing the CrN bonding layer to a thickness of about 0.5 to 5 μm, and the depositing of the TiAlN/CrN nano multi-layer further comprises depositing the TiAlN/CrN nano multi-layer to a thickness of about 0.5 to 5 μm.

7. The method of claim 4, wherein the depositing of the TiAlN/CrN nano multi-layer further comprises depositing the TiAlN/CrN nano multi-layer (120) to obtain a ratio of 1:1:1: of the Ti, Al and Cr in the TiAlN/CrN nano multi-layer.

8. The method of claim 4, wherein the depositing of the TiAlN/CrSiN nano multi-layer further comprises depositing the TiAlN/CrSiN nano multi-layer to obtain a ratio of 1:1:0.9:0.1 of the Ti, Al, Cr and Si in the TiAlN/CrSiN nano multi-layer.

9. The method of claim 4, wherein the deposition is performed using a physical vapor deposition method.

10. A method of manufacturing of the coating material for an aluminum die casting mold, comprising:
depositing a CrN bonding layer on a surface of a substrate using a Cr target in response to forming a nitrogen gas (N₂) atmosphere by projecting nitrogen gas (N₂) through a gas inlet of a chamber;
depositing a TiAlN/CrN nano multi-layer on a surface of the deposited CrN bonding layer using a TiAl target and the Cr target; and
depositing a TiAlN/CrSiCN nano multi-layer on a surface of the deposited TiAlN/CrN nano multi-layer using the TiAl target and a CrSi target in response to forming an acetylene gas (C₂H₂) atmosphere by projecting acetylene gas (C₂H₂) through the gas inlet of the chamber.

11. The method of claim 10, wherein the depositing of the TiAlN/CrSiCN nano multi-layer further comprises depositing the TiAlN/CrSiN nano multi-layer to a thickness of about 0.5 to 5 μm.

12. The method of claim 11, wherein the depositing of the CrN bonding layer further comprises depositing the CrN bonding layer to a thickness of about 0.5 to 5 μm and the depositing of the TiAlN/CrN nano multi-layer further comprises by depositing the TiAlN/CrN nano multi-layer to a thickness of about 0.5 to 5 μm.

13. The method of claim 10, wherein the depositing of the TiAlN/CrN nano multi-layer further comprises depositing the TiAlN/CrN nano multi-layer to obtain a ratio of 1:1:1 of the Ti, Al and Cr in the TiAlN/CrN nano multi-layer.

14. The method of claim 10, wherein the depositing of the TiAlN/CrSiCN nano multi-layer is performed by depositing the TiAlN/CrSiCN nano multi-layer so that Ti, Al, Cr, Si and C in the TiAlN/CrSiCN nano multi-layer amount to a ratio of 1:1:0.8:0.1:0.1.

15. The method of claim 10, wherein the deposition is executed using a physical vapor deposition method.
